(19) United States
(12) Patent Application Publication
(10) Pub. No.: US 2008/0256998 A1
(43) Pub. Date: Oct. 23, 2008

(54) SYSTEM AND APPARATUS FOR PROTECTING EQUIPMENT SENSITIVE TO ELECTRO-STATIC DISCHARGE

(75) Inventors: DOLORES J. MALLIAN, ST. CHARLES, IL (US); BRUCE BARNES, CRYSTAL LAKE, IL (US); WAYNE R. HEINMILLER, ELGIN, IL (US); CHARLES STAHULAK, CHICAGO, IL (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/738,930

(22) Filed: Apr. 23, 2007

(51) Int. Cl. E05B 47/00; H05F 1/00

(52) U.S. Cl. 70/275; 340/649

(57) ABSTRACT

A system and apparatus for protecting equipment sensitive to electro-static discharge is disclosed. A system that incorporates teachings of the present disclosure may include, for example, an Electro-Static Discharge (ESD) key entry system for providing access to a restricted area that includes a locking element, a wireless element, and a controller element to manage operations of the locking element and the wireless element. The controller element can wirelessly detect an ESD protector in a vicinity to the ESD key entry system and enable the locking element to provide access to the restricted area. Additional embodiments are disclosed.

### FIELD OF THE DISCLOSURE

The present disclosure relates generally to protecting equipment, and more specifically to a system and apparatus for protecting equipment sensitive to electro-static discharge.

### BACKGROUND

Electro-Static Discharge (ESD) is known to interfere with the proper functioning of telecommunications and data equipment. In general, ESD interference can be reduced by requiring users to utilize ESD protective devices such as wrist straps, anti-static garments, or anti-static floor mats. Enforcement of these requirements, such as through policies or notice, can be difficult. ESD interference can also be reduced by placing ESD-sensitive equipment within controlled access locations. However, authorized personnel with or without ESD protective devices may still be able to enter the controlled location.

A need therefore arises for a system and apparatus for protecting equipment from ESD exposure.

### BRIEF DESCRIPTION OF THE DRAWINGS

FIG. 1 depicts an exemplary embodiment of an electro-static discharge (ESD) key entry system;

FIG. 2 depicts an exemplary embodiment of the electro-static discharge (ESD) key entry system operating at an access point to a restricted area;

FIG. 3 depicts an exemplary method operating at the access point to the restricted area; and

FIG. 4 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a system and apparatus for protecting equipment sensitive to electro-static discharge.

In a first embodiment of the present disclosure, an Electro-Static Discharge (ESD) key entry system for providing access to a restricted area can include a locking element, a wireless element, and a controller element to manage operations of the locking element and the wireless element, where the controller element wirelessly detects an ESD protector in a vicinity to the ESD key entry system and enables the locking element to provide access to the restricted area.

In a second embodiment of the present disclosure, an Electro-Static Discharge (ESD) protector can include a wireless element to transmit a signal to enable access to a restricted area.

In a third embodiment of the present disclosure, a Radio Frequency Identification (RFID) tag can include a wireless element utilized by an Electro-Static Discharge (ESD) protector to enable access to a restricted area.

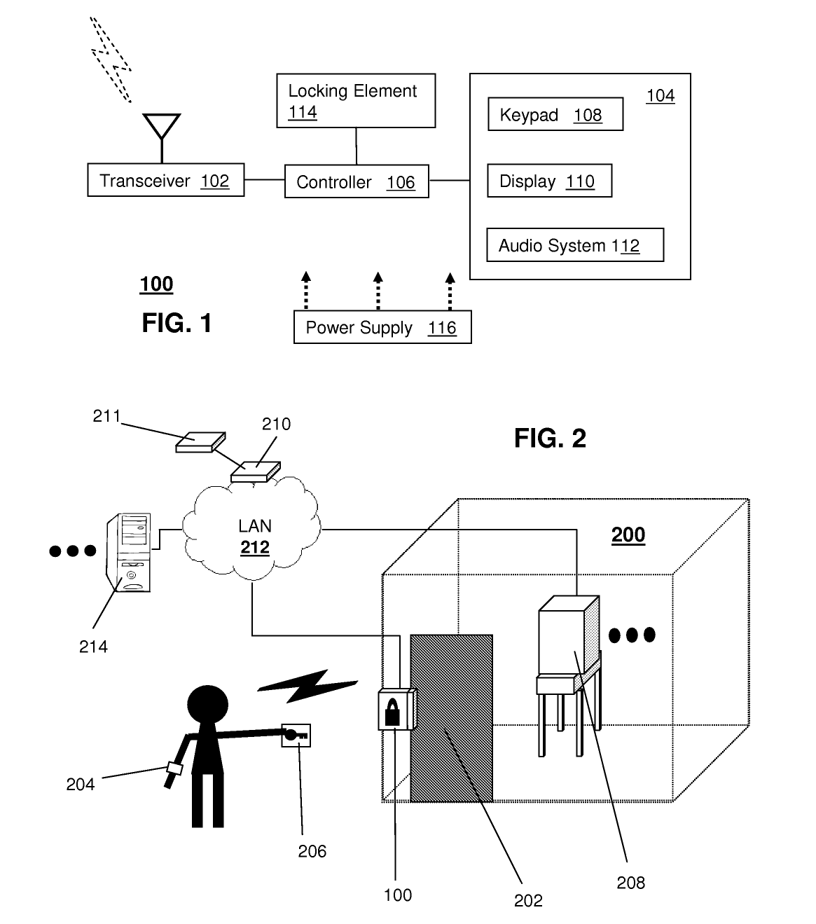

FIG. 1 depicts an exemplary embodiment of an Electro-Static Discharge (ESD) key entry system (KES) 100 for providing access to a restricted area. The KES 100 can comprise a wireless and/or wireline transceiver 102, a user interface (UI) 104, a locking element 114, a power supply 116, and a controller 106 for managing operations of the foregoing components. The transceiver 102 can utilize common communication technologies to support singly or in combination any number of wireline access technologies such as Ethernet, cable, xDSL, Public Switched Telephone Network (PSTN), and so on.

Singly or in combination with the wireline technology, the transceiver 102 can be configured as a wireless element supporting singly or in combination any number of wireless access technologies including without limitation infrared, Digital Enhanced Cordless Telecommunications (DECT), Bluetooth™, Wireless Fidelity (WiFi), Worldwide Interoperability for Microwave Access (WiMAX), Ultra Wide Band (UWB), software defined radio (SDR), and cellular access technologies such as CDMA-1×, W-CDMA/HSDPA, GSM/GPRS, TDMA/EDGE, and EVDO. SDR can be utilized for accessing public and/or private communication spectrum with any number of communication protocols, such as by dynamically downloading over-the-air to the KES 100. Next generation wireline and wireless access technologies can also be applied to the present disclosure.

The UI element 104 can include a keypad 108 with depressible or touch sensitive keys and a navigation element such as a navigation disk, button, roller ball, or flywheel for manipulating operations of the KES 100. The UI element 104 can include a display 110 such as monochrome or color LCD (Liquid Crystal Display) which can be touch sensitive for manipulating operations of the KES 100 and for conveying images to the end user of said device, including text messages. Alternatively or in combination, the display 110 can include a series of lamps such as light emitting diodes (LEDs) or incandescent light bulbs configured as status or response indicators. The UI element 104 can additionally include an audio system 112 that utilizes common audio technology for conveying audible signals to, and/or intercepting audible signals from, the end user.

The locking element 114 can utilize common access control technologies to limit access to restricted areas. The locking element 114 can include a bolting system that can lock and unlock, for example, a door that leads to a restricted area. Bolting systems can include various types of bolting systems, including mechanical bolting systems, electrical or electronic bolting systems, or any combination thereof. For example, mechanical bolting systems can include key systems having a housing assembly that can require a user to physically engage a key with the housing of the bolting system to obtain access. An electrical bolting system can include key systems that can include a key having a transmitter to communicate with the bolting system, such as wirelessly. In one embodiment, a key can transmit signals to the KES 100 compatible with any of the 802.xx protocols as defined by the Institute of Electrical and Electronics Engineers (IEEE). In another example, the locking element 114 can be configured as an RFID reader and the key can include a passive RFID tag having an antenna, a transmitter coupled to the antenna, a memory element, and a controller element to manage operation of the components of the RFID tag. Similarly, the key can include a power supply to provide an active RFID tag. The present disclosure also contemplates the key communicating with the bolting system through contact, such as completing a circuit or transmitting a signal when contact is made.

The power supply 116 can utilize common power management technologies such as replaceable batteries, supply regulation technologies, and charging system technologies for supplying energy to the components of the KES 100. KES 100 can be an immobile or portable communication device. Power can be derived from various sources, including a common AC outlet, a cable interface using Power over Ethernet, or other suitable power source means. The controller 106 can utilize computing technologies such as a microprocessor and/or digital signal processor (DSP) with associated storage memory such as Flash, ROM, RAM, SRAM, DRAM or other like technologies for controlling operations of the KES 100.

The KES 100 can be an integrated device or can be in a distributed configuration, such as in a master-slave arrangement. In the latter embodiment, the components of the KES 100 can be reused in different form factors for the master and slave KES.

FIG. 2 depicts an exemplary embodiment of the KES 100 controlling access to a restricted area 200 at an access point 202. In this embodiment, the restricted area 200 can comprise a room, a building, or any other structure or location housing ESD sensitive equipment 208. However, the restricted area 200 is not limited only to building structures and can include smaller physical spaces, such as cabinets or other types of small enclosures that equipment 208 is located in. The ESD sensitive equipment 208 can be any device, system, material and/or entity that is sensitive to electro-static discharge, including electronic equipment.

As illustrated in FIG. 2, a user equipped with an ESD protective device 204 can interact with the KES 100 to request access to enter a restricted area 200, such as to use one or more pieces of ESD sensitive equipment 208 located therein. For example, the user can present a key 206 to the KES 100. Additionally, the restricted area 200 can have one or more access points 202 for user entry controlled by one or more of the KES's 100. In the illustrated embodiment, each access point 202 can comprise an entryway including a door, a gate, or any other type of mechanical entry device. Multiple KES's 100 or a master-slave arrangement of KES's can be used to provide a KES 100 at each access point 202. Furthermore, an access point 202 can comprise a cover, a shield, or any other type of barrier to limit access to the ESD sensitive equipment 208. The present disclosure contemplates electronic devices and techniques being utilized to limit access to the restricted area 200. For example, the access point 202 can include entry sensors, including motion detectors coupled to an alarm system, to limit access to the restricted area 200, such as through an open but monitored entryway. In some instances, a combination of mechanical and/or electronic devices can be used to limit access to the restricted area.

A KES 100 can be coupled to a network proxy 210 that can provide a secure wired and/or wireless local area network (LAN) 212 in a residential or commercial setting. The network proxy 210 can include various components and applications, such as a router and firewall. One or more remote servers 214 for accessing or managing data or applications of the KES 100 can also be coupled to the LAN 212 via the network proxy 210. Additionally, the network proxy 210 can also provide access to remote networks via a gateway 211. The network proxy 210 can also couple one or more of the ESD sensitive equipment 208 to the LAN 212 and the KES 100.

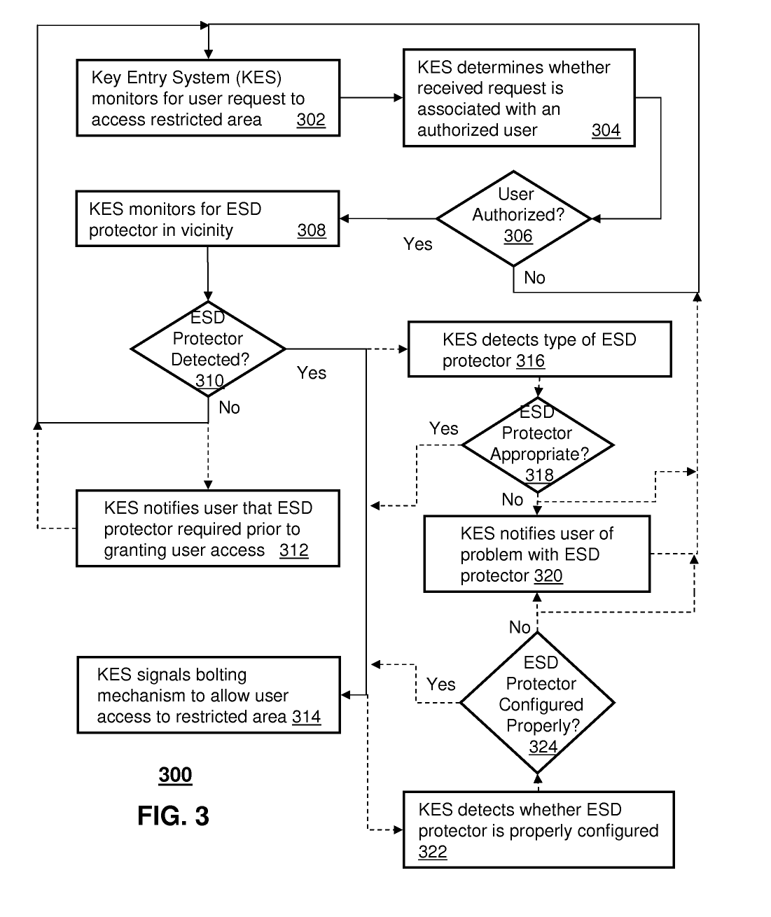

FIG. 3 depicts an exemplary embodiment of a method 300 operating in portions of the restricted area 200. Method 300 has variants as depicted by the dashed lines. It would be apparent to an artisan with ordinary skill in the art that other embodiments not depicted in FIG. 3 are possible without departing from the scope of the claims described below.

Method 300 begins with step 302 in which the KES 100 monitors for a user request to access the restricted area 200 and the ESD-sensitive equipment 208 therein. The user can provide a user request for access by presenting a key 206 for the locking element 114 of KES 100. However, the type of key system and the key 206 can vary. For example, the key system can accept a user-supplied code key as the key 206. In such instances, a user can enter a code key into a UI 104 of the KES 100. Code keys can be used to limit access to restricted areas 200 on a per user basis. The code key can be a user ID, a password, a personal identification number (PIN), a biometric ID (e.g., voice, fingerprint, retina, etc.) or other suitable form of identification information which can be verified by the KES 100 prior to granting access to the restricted area 200.

In another embodiment, the key system can be configured to accept a physical key, such as a traditional key, a keycard, or other object. In such instances, the user can engage the physical key with a housing of the key system of the KES 100. For example, the user can insert a mechanical key into a keyhole or insert a key card into a slot. In another embodiment, the KES 100 can be configured to detect the insertion or interaction of the key 206 with the locking element 114 of the KES using one or more sensors. In yet another embodiment, the key 206 can be equipped with a wireless transmitter, that can be activated by the KES 100 when the key 206 is physically engaged with the KES 100, to transmit a signal or a message to the KES 100. In these embodiments, the KES 100 can be configured to determine the code key from the physical key. For example, a code key can be included in the signal transmitted to the KES 100 or generated by the physical interaction of the physical key with the housing of the locking element 114.

In one embodiment, the KES 100 can be configured to continually monitor for signals from a wireless transmitter in possession of the user so that physical engagement of a key with the locking element 114 is unnecessary. For example, a key card or an RFID tag can be configured to wirelessly interact with the KES 100 and transmit a signal to the KES 100, including an code key.

In step 304, upon receipt of a request for user access to a restricted area, the KES 100 can determine if the code key received by the KES is associated with a user authorized for access to the restricted area 200. The KES 100 can determine whether a user is authorized in several ways. For example, the KES 100 can be configured to compare a received code key to a list of code keys stored in the KES 100. In another example, the KES 100 can be configured to access the remote server 214 or the equipment 208 for code key information. In yet another example, the list of authorized code keys can be stored in a master KES 100 and can be communicated to a slave KES as needed.

If the KES 100 determines that the user is authorized in step 306, then the KES 100 proceeds to step 308 to determine whether an ESD protector 204 is also present. However, if the code key is invalid, the KES 100 can reject the user request and return to step 302. In one embodiment, the KES 100 can reject additional access attempts after several consecutive authorization failures. In the case of a code key input via a UI 104 of the KES 100, the KES 100 can, for example, reject further attempts for a period of time to reduce the possibility of an unauthorized user guessing a code key. In another embodiment, the KES 100 can submit a notice of possible tampering to an administrator by way of, for example, an email, or over-the-air message.

In step 308, the KES 100 can wirelessly monitor the vicinity of the access point 202 and/or the KES 100 to determine whether a user is carrying or wearing one or more ESD protectors 204. For example, an ESD protector 204 can include a wireless transmitter operating according to one among the group of IEEE 802.xx protocols to transmit a signal or a message to the KES 100. In another example, the ESD protector 204 can include an RFID tag configured to transmit a signal to an RFID reader of the KES 100.

If the KES 100 in step 310 fails to detect a signal from the ESD protector 204, the KES 100 can reject the user request and return to step 302. Additionally, the KES 100 in step 312 can notify a user via the UI 104 that the ESD protector is not being detected by the KES 100. However, if the KES 100 does detect the presence of an ESD protector in step 310, the KES 100 in step 314 can signal the locking element 114 to, for example, unlock a bolting system of a door to allow the user access to the restricted area 200.

In one embodiment, separately or in combination with step 310, the KES 100 in step 316 can determine the types of ESD protectors present and in step 318 can determine whether the detected ESD protectors 204 are appropriate or sufficient for the restricted area 200. For example, one or more ESD protectors 204 can be configured to transmit a signal that includes an identification of the type of ESD protector. The KES 100 can determine whether the ESD protector 204 is appropriate by comparing the transmitted identification to a list of authorized ESD protectors stored in the KES 100 or elsewhere. As another example, an anti-static garment can be configured to transmit a different identification signal than a wrist strap. The KES 100 can be configured to allow access to extremely ESD-sensitive areas only to those users wearing anti-static garments and deny access to those users wearing only a wrist strap. In yet another example, several types or pieces of ESD protectors 204 can be required for entry into a restricted area 200, and the KES 100 can be configured to only allow access to users having each and every ESD protector required. In another example, the KES 100 can be configured to provide users access to the restricted area 200 as long as they have one or more acceptable ESD protectors 204 from a pre-defined list. The KES 100 can be configured to allow access to persons having anti-static garments, a wrist strap, or both. However, if the KES 100 determines that the proper ESD protectors 204 are not present, the KES 100 can reject the user request.

In another embodiment, the KES 100 can be configured in step 320 to provide the user with the reason for the denial of access to the restricted area 200. For example, the KES 100 can notify the user via the UI 104 that specific ESD protectors are missing or that the detected ESD protectors 204 are inappropriate for the restricted area 200. However, if the KES 100 does detect the presence of a proper type of ESD protector in step 318, the KES 100 can signal the locking element 114 to, for example, unlock a bolting mechanism and allow the user access to the restricted area, as recited back in step 314.

In another embodiment, separately, or in combination with steps 310 and 316, the KES in step 322 can determine whether one or more ESD protectors 204 are properly configured or operable for the restricted area 200. In some instances, one or more ESD protectors 204 can be configured to transmit a detection signal to the KES 100 only when properly worn by the user. For example, a wrist strap ESD protector 204 can be configured to include a transmitter circuit that closes only when the wrist strap is properly fastened. In other instances, the KES 100 can be configured to determine whether ESD protectors 204 are located at expected locations on a user's body. For example, if a user requests access to the restricted area 200 and anti-static foot coverings are required for access, the KES 100 can determine whether the user is wearing the foot coverings by including an RFID reader in a floor mat at the access point 202 to activate and read an RFID tag included in a foot covering. However, if the KES 100 determines in step 324 that the proper ESD protectors are not properly configured, the KES 100 can reject the user request and return to step 302. Additionally, the KES 100 can be configured in step 320 to notify a user as to the cause of the access failure. If the KES 100 does detect the ESD protector 204 is properly configured in step 324, the KES 100 can signal the locking element 114 to, for example, unlock a bolting mechanism to allow the user access to the restricted area 200.

Upon reviewing the foregoing embodiments, it would be evident to an artisan with ordinary skill in the art that said embodiments can be modified, reduced, or enhanced without departing from the scope and spirit of the claims described below. In one embodiment, one or more of the steps in method 300 can be completed in one or more components accessible to the KES 100. For example, authentication of a code key can be completed by one or more remote servers 214, by a piece of equipment 208, or by any external components accessible via the network proxy 210. In another embodiment, the key 206 can be incorporated into the ESD protector 204, and can include ESD information and user authentication/identification information. In another embodiment, user authentication (such as in steps 304 and 306) can be eliminated and access can be granted to users based on the detection of ESD protectors 204. In another embodiment, alternatively or in combination with limiting access to the restricted area 200, access to individual pieces of equipment 208 can also be provided by associating particular code keys with certain pieces of equipment.

From these illustrations, it would be evident to said artisan that many modifications can be made to the present disclosure without departing from the scope of the claims stated below. Accordingly, the reader is directed to the claims section for a fuller understanding of the breadth and scope of the present disclosure.

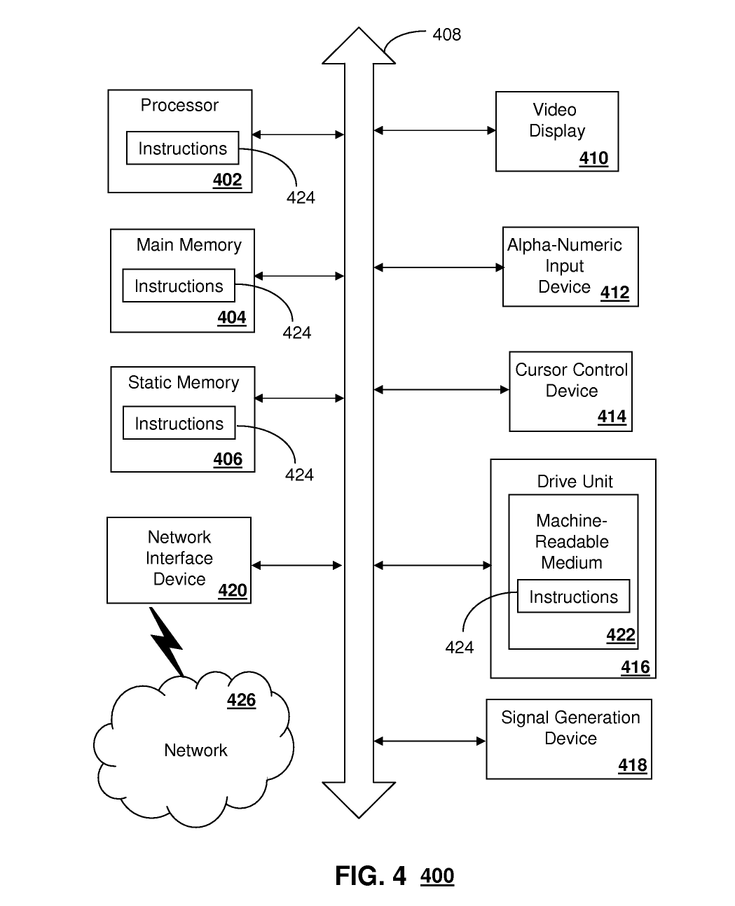

FIG. 4 depicts an exemplary diagrammatic representation of a machine in the form of a computer system 400 within which a set of instructions, when executed, can cause the machine to perform any one or more of the methodologies discussed above. In some embodiments, the machine operates as a standalone device. In some embodiments, the machine can be connected (e.g., using a network) to other machines. In a networked deployment, the machine can operate in the capacity of a server or a client user machine in server-client user network environment, or as a peer machine in a peer-to-peer (or distributed) network environment.

The machine can comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 can include a processor 402 (e.g., a central processing unit (CPU), a graphics processing unit (GPU, or both), a main memory 404 and a static memory 406, which communicate with each other via a bus 408. The computer system 400 can further include a video display unit 410 (e.g., a liquid crystal display or LCD), a flat panel, a solid state display, or a cathode ray tube (CRT)). The computer system 400 can include an input device 412 (e.g., a keyboard), a cursor control device 414 (e.g., a mouse), a disk drive unit 416, a signal generation device 418 (e.g., a speaker or remote control) and a network interface device 420.

The disk drive unit 416 can include a machine-readable medium 422 on which is stored one or more sets of instructions (e.g., software 424) embodying any one or more of the methodologies or functions described herein, including those methods illustrated above. The instructions 424 can also reside, completely or at least partially, within the main memory 404, the static memory 406, and/or within the processor 402 during execution thereof by the computer system 400. The main memory 404 and the processor 402 also can constitute machine-readable media.

Dedicated hardware implementations including, but not limited to, application specific integrated circuits, programmable logic arrays and other hardware devices can likewise be constructed to implement the methods described herein. Applications that can include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 can further be transmitted or received over a network 426 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments can be utilized and derived therefrom, such that structural and logical substitutions and changes can be made without departing from the scope of this disclosure. Figures are also merely representational and can not be drawn to scale. Certain proportions thereof may be exaggerated, while others may be minimized. Accordingly, the specification and drawings are to be regarded in an illustrative rather than a restrictive sense.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An Electro-Static Discharge (ESD) key entry system for providing access to a restricted area, comprising:
a locking element;
a wireless element; and
a controller element to manage operations of the locking element and the wireless element, wherein the controller element:
wirelessly detects an ESD protector in a vicinity to the ESD key entry system; and
enables the locking element to provide access to the restricted area.

2. The ESD key entry system of claim 1, wherein the locking element comprises a bolting system that locks and unlocks a door that leads to the restricted area responsive to instructions supplied by the controller element.

3. The ESD key entry system of claim 1, wherein the locking element comprises a key system that locks and unlocks a bolting system of a door that leads to the restricted area responsive to instructions supplied by the controller element.

4. The ESD key entry system of claim 3, wherein the key system comprises a housing assembly to physically engage with the bolting system.

5. The ESD key entry system of claim 3, wherein the key system comprises a wireless transmitter to wirelessly engage with the bolting system.

6. The ESD key entry system of claim 5, wherein the wireless transmitter operates according to one among a group of 802.xx protocols defined by the Institute of Electrical and Electronics Engineers (IEEE).

7. The ESD key entry system of claim 1, wherein the wireless element comprises a Radio Frequency Identification (RFID) reader.

8. The ESD key entry system of claim 1, wherein the ESD protector comprises a Radio Frequency Identification (RFID) tag.

9. The ESD key entry system of claim 8, wherein the RFID tag is at least one among an active RFID tag and a passive RFID tag.

10. The ESD key entry system of claim 1, wherein the controller element:
wirelessly receives from the ESD protector a code; and
enables the locking element to provide access to the restricted area responsive to validating said code.

11. The ESD key entry system of claim 10, wherein the code comprises at least one among a first identification of a type of ESD protector, and a second identification that identifies an owner of said ESD protector.

12. An Electro-Static Discharge (ESD) protector, comprising a wireless element to transmit a signal to enable access to a restricted area.

13. The ESD protector of claim 12, wherein the wireless element transmits information associated with the ESD protector to an ESD key entry system to enable access to the restricted area.

14. The ESD protector of claim 13, wherein the wireless element transmits said information responsive to a request from said ESD key entry system.

15. The ESD protector of claim 13, wherein the wireless element transmits said information responsive to the ESD protector being properly worn by an end user of said ESD protector.

16. The ESD protector of claim 12, wherein the wireless element comprises a wireless transmitter operating according to one among a group of 802.xx protocols defined by the Institute of Electrical and Electronics Engineers (IEEE).

17. The ESD protector of claim 12, wherein the wireless element comprises a Radio Frequency Identification (RFID) tag, and wherein the RFID tag is at least one among an active RFID tag and a passive RFID tag.

18. The ESD protector of claim 17, wherein the RFID tag comprises:
an antenna;
a transmitter coupled to the antenna;
a memory that stores information associated with the ESD protector; and
a controller element that directs the transmitter to transmit a portion of said stored information to an ESD key entry system to enable access to the restricted area.

19. The ESD protector of claim 18, wherein the information associated with the ESD protector comprises at least one among a first identification of a type of ESD protector, and a second identification that identifies an owner of said ESD protector.

20. A Radio Frequency Identification (RFID) tag, comprising a wireless element utilized by an Electro-Static Discharge (ESD) protector to enable access to a restricted area.

21. The RFID tag of claim 20, wherein the RFID tag is at least one among an active RFID tag and a passive RFID tag, and wherein the wireless element comprises:
an antenna;
a transmitter coupled to the antenna;
a memory that stores information associated with the ESD protector; and
a controller element that directs the transmitter to transmit a portion of said stored information to an ESD key entry system to enable access to the restricted area.

22. The RFID tag of claim 21, wherein the information associated with the ESD protector comprises at least one among a first identification of a type of ESD protector, and a second identification that identifies an owner of said ESD protector.
